(19) United States
(12) Patent Application Publication
(10) Pub. No.: US 2007/0013608 A1
(43) Pub. Date: Jan. 18, 2007

(54) Dual display electronic device

(76) Inventors: Siew Chan Goo, Melaka (MY); Hean Chin Tan, Singapore (SG)

Correspondence Address: MOTOROLA INC, 600 NORTH US HIGHWAY 45, ROOM AS437, LIBERTYVILLE, IL, 60048-5343, US

(21) Appl. No.: 11/179,379

(22) Filed: Jul. 12, 2005

(51) Int. Cl. G09G 5/00

(52) U.S. Cl. 345/1.1

(57) ABSTRACT

A dual display electronic device (100) has a housing (201) comprising a first housing member (180) and a second housing member (190) movably mounted to each other to allow relative movement between an open position and a closed position. The first housing member (180) and the second housing member (190) each having an inner face (316,309) such that at least part of the inner face (309) of the second housing member (190) is facing and is proximal to the inner face (316) of the first housing member when the device is in a closed position. A first display screen (150) is located on the inner face (316) of the first housing member (180) and is visible via an opening (204) in the second housing member (190) when the device (100) is in the closed position. A second display screen (155) is located on the inner face (309) of the second housing member (109) and is locatable in side by side juxtaposition with the first screen display (150) when the device (100) is in the open position. At least one user input interface (106) is mounted to the housing (101).

### FIELD OF THE INVENTION

The present invention relates generally to an electronic device having a dual display arrangement.

The present invention relates particularly although not exclusively to a portable electronic device such as a mobile telephone having a dual display facility.

### BACKGROUND

Conventional electronic devices such as mobile telephones, hand held personal computers and personal digital assistants (PDA's) with mobile telephone capabilities have multiple functionalities. Such functionalities include the ability to make and receive telephone calls; prepare, send and receive data such as Short Message Service (SMS), Multimedia Message Service (MMS), Enhanced Message Service (EMS) messages and documents; take digital photographs; play games; navigate menus, web pages and the like.

Many of these portable electronic devices have a “clam shell” configuration wherein a protective cover is pivotally mounted to the body of such a device to move between an open position wherein a user interface such as a keypad and a display screen are exposed and a closed position wherein the keypad and display screen are covered by the protective cover.

Another type of portable electronic device has a protective cover pivotally mounted to the device body wherein the protective cover pivots about a pivotal axis perpendicular to the plane in which the keypad and display screen lie on the device body. Again, the protective cover pivots from a closed position wherein the keypad and display screen are obscured to an open position wherein the keypad and display screen are exposed.

For the added convenience of users of these portable electronic devices, some manufacturers have provided a small display screen in the protective cover to provide a limited amount of information to a user without having to open the device to access the main display screen. The small display screen may display such information as time, date, the nature of a message received such as telephone, SMS, MMS or EMS, the identity of a message sender, battery condition or the like.

With the increasing popularity of digital photography functionality in portable electronic devices and the availability of multi media messaging services, streaming video sources and wireless computer game services, there is a greater demand for display screens of larger size to accommodate larger images and larger text messages. The competing requirement on one hand for manufacturers of portable electronic devices to provide greater functionality and on the other hand to manufacture more compact devices has resulted in a compromise between the area occupied by a display screen and the area occupied by a keypad on the bodies of such electronic devices.

### SUMMARY OF THE INVENTION

In one form, the invention provides an electronic device comprising a housing having a first housing member and a second housing member movably mounted to each other to allow relative movement thereof between an open position and a closed position, the first housing member and the second housing member each having an inner face such that at least part of the inner face of the second housing member is facing and proximal to the inner face of the first housing member when the device is in the closed position. A first display screen is located on the inner face of the first housing member and is visible via an opening in the second housing member when the device is in a closed position. A second display screen is located on the inner face of the second housing member and is locatable in a substantially edge to edge juxtaposition with the first display screen when the device is in an open position. The device has at least one user input interface mounted to the housing.

If required, the first display screen may protrude into the opening in the second housing member when the device is in the closed position.

Suitably, the second housing member and the first housing member are pivotally mounted to each other about a pivotal axis slidably movable between a position adjacent one end of the first housing member and a position intermediate opposite ends of the first housing member.

Preferably, the second housing member is axially slidable along a longitudinal axis of the electronic device in an open position to bring adjacent edges of the first display screen and the second display screen into side by side juxtaposition with respective exposed screen surfaces lying substantially coplanar.

The second housing member and the first housing member may be lockable in the open position by a locking mechanism.

Suitably, the locking mechanism comprises a socket and spigot mechanism.

Preferably, the socket and spigot mechanism comprises an electrical coupling between the second body member and the first body member.

If required, the first display screen and the second display screen together function as single large display screen when the device is in the open position.

Alternatively, the first display screen and the second display screen function as two separate display screens when the device is in the open position.

The user input interface may comprise one or more keypads mounted on said first housing member.

If required, the user input interface comprises at least one touch sensitive display screen.

The at least one touch sensitive display screen may be incorporated into the first display screen.

If required, the user interface may include a first interface incorporated in the first housing member and a second interface incorporated in the second housing member, wherein the first interface and second interface are located adjacent respective free ends of the first housing member and the second housing member.

### BRIEF DESCRIPTION OF THE FIGURES

In order that the invention may be readily understood and put into practical effect, reference will now be made to exemplary embodiments as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic circuit diagram of an electronic device in accordance with an embodiment of the invention;

FIG. 2 is a perspective view of the electronic device in accordance with an embodiment of the invention when the device is in a closed position;

FIG. 3 is a perspective view of the of the electronic device of FIG. 2 in an initial open position;

FIG. 4 is a plan view of the electronic device of FIG. 3 in a final open position;

FIG. 5 shows schematically a cross-sectional view through 2-2′ of FIG. 2;

FIG. 6 is a perspective view of the device in accordance with an alternative embodiment of the invention when the device is in a closed position;

FIG. 7 shows the device of FIG. 6 in the open position; and

FIG. 8 shows schematically, a cross-sectional view through 6-6′ of FIG. 6.

Skilled artisans will appreciate that elements in the figures are illustrated for simplicity and clarity and have not necessarily been drawn to scale. For example, the dimensions of some of the elements in the figures may be exaggerated relative to other elements to help or improve the understanding of the embodiments of the invention.

### DETAILED DESCRIPTION

Before describing in detail embodiments that are in accordance with the present invention, it should be observed that the embodiments reside primarily in combinations of apparatus components related to a dual display electronic device. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises”, “comprising”, or any other variation thereof, are intended to cover a non-exclusive inclusion, such that a device that comprises a list of elements does not include only those elements but may include other elements not expressly listed or inherent to device. An element preceded by “comprises . . . a” does not, without more constraints, preclude the existence of additional identical elements in the device.

It will be appreciated that embodiments of the invention described herein may be comprised of one or more conventional processors and unique stored program instructions that control the one or more processors to implement, in conjunction with certain non-processor circuits, some, most, or all of the functions of the dual display electronic device described herein. The non-processor circuits may include, but are not limited to, a radio receiver, a radio transmitter, signal drivers, clock circuits, power source circuits, and user input devices.

Some or all functions of the dual display electronic device could be implemented by a state machine that has no stored program instructions, or in one or more application specific integrated circuits (ASICs), in which each function or some combinations of certain of the functions are implemented as custom logic. Of course, a combination of the two approaches could be used. Thus, functions and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

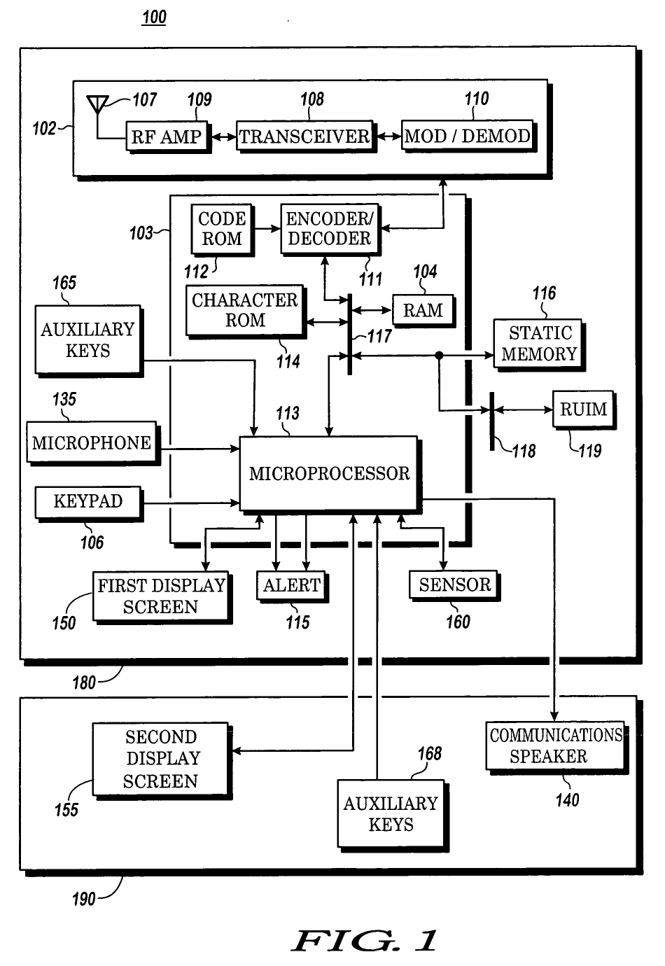

Referring to FIG. 1, there is a schematic circuit diagram illustrating an example of an electronic device 100 typically in the form of a mobile station or mobile telephone comprising a radio frequency communications unit 102 coupled to be in communication with a processor 103. The electronic device 100 also has a keypad 106, first auxiliary keys (buttons) 165, a first display screen 150, a second display screen 155, a sensor 160, and optionally, second auxiliary keys 168. There is also an alert module 115 that typically contains an alert speaker, vibrator motor and associated drivers. The keypad 106, first display screen 150, second display screen 155, alert module 115, auxiliary keys 165, optional auxiliary keys 168, and sensor 160 are coupled to be in communication with the processor 103. It is envisaged that first display screen 150 or an area thereof may be in the form of a touch screen providing a user input interface and therefore the keypad 106 could be optional or the user input interface may comprise both the keypad 106 and first display screen 150. Similarly, second display screen 155 or an area thereof may be in the form of a touch screen providing a user input interface and therefore the auxiliary keys 168 could be optional or the user input interface may comprise both the auxiliary keys 168 and the second display screen 155.

The processor 103 includes an encoder/decoder 111 with an associated code Read Only Memory (ROM) 112 for storing data for encoding and decoding voice or other signals that may be transmitted or received by the communications device 100. The processor 103 also includes a micro-processor 113 coupled, by a common data and address bus 117, to the encoder/decoder 111, a character Read Only Memory (ROM) 114, a Random Access Memory (RAM) 104, static programmable memory 116 and a Removable User Identity Module (RUIM) interface 118. The static programmable memory 116 and a RUIM card 119 (commonly referred to as a Subscriber Identity Module (SIM) card) operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static memory 116 may also store passwords for allowing accessibility to password-protected functions on the mobile telephone 100.

The micro-processor 113 has ports for coupling to the keypad 106, first display screen 150, second display screen 155, alert module 115, auxiliary keys 165, auxiliary keys 168, and sensor 160. Also, micro-processor 113 has ports for coupling to an integral microphone 135 and an integral communications speaker 140 that are integral with the device 100. As shown, the second display screen 155, auxiliary keys 168 and communications speaker 140 are located in a second housing member 190 and all other aforementioned modules and units are located in a first housing member 180.

The character Read Only Memory 114 stores code for decoding or encoding text messages that may be received by the communications unit 102. In this embodiment the character Read Only Memory 114, RUIM card 119, and static memory 116 may also store Operating Code (OC) for the micro-processor 113 and code for performing functions associated with the mobile telephone 100.

The radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that couples the communications unit 102 to the processor 103.

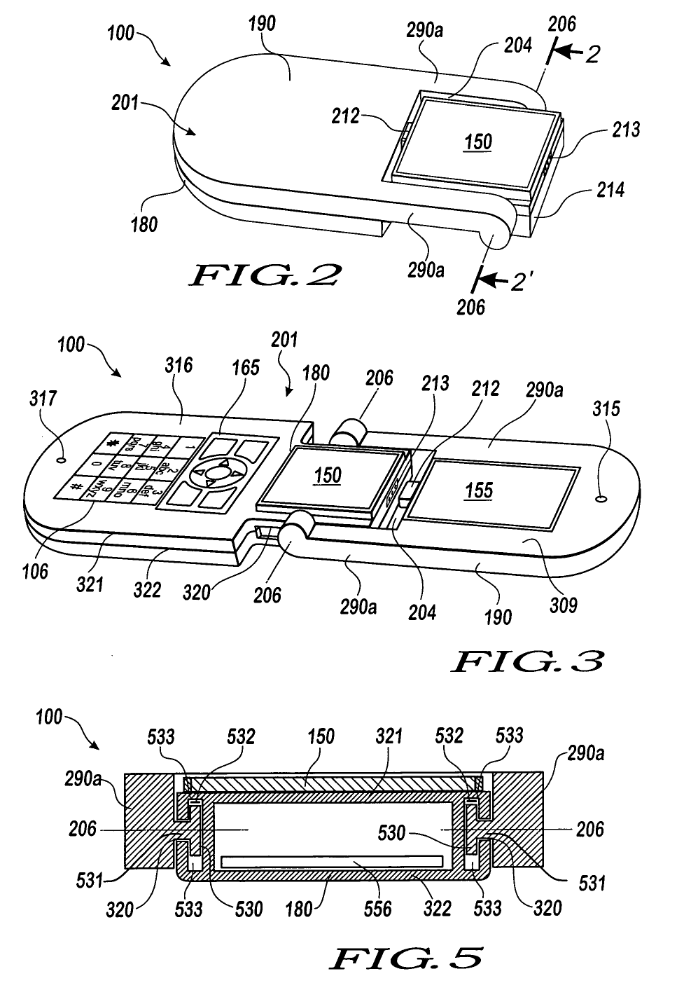

FIG. 2 illustrates the electronic device 100 according to an embodiment of the invention, the device 100 being in the form of a mobile telephone in a closed position. The device 100 has a “clam shell” type housing 201 with the first housing member 180 and a second housing member 190 movably mounted to each other about a pivotal axis 206. Second housing member 190 forms the upper or top “flip” of the housing 201 and is formed with a slot or opening 204 between arms 290a through which the first display screen 150 protrudes into and is thereby visible when the device 100 is in the closed position. The first display screen 150 is mounted on the first housing member 180 and the second display screen 190 is hidden when the electronic device 100 is in the closed position. An electrical socket 213 is mounted in an end face 214 of first housing member 180.

FIG. 3 illustrates the electronic device 100 in an initial open position wherein the second housing member 190 is rotated through 180° about pivotal axis 206 to reveal the keypad 106 and auxiliary keys 165 mounted on an inner face 316 of first housing member 180. Also the first display screen 150 is located on the inner face 316 and Located on an inner face 309 of second housing member 190 is the second display screen 155. As will be apparent to a person skilled in the art, when the electronic device is in the closed position, at least part of the inner face 309 is facing and proximal to the inner face 316. Mounted at the inner transverse edge 311 of slot or opening 204 in second housing member 190 is an electrical spigot 212 aligned with an electrical socket 213 located in end face 214 of first housing member 180 to facilitate an electrical coupling between the second display screen 155 and processor 103.

A microphone aperture 317 is provided in the inner face 316 of first housing member 180 and a communication speaker aperture 315 is provided in an inner face 309 of the second housing member 190.

As illustrated in FIG. 3, arms 290a are slidably mounted to and captive in tracks provided by elongate apertures 320 formed between housing elements 321,322, which housing elements together form first housing member 180. The engagement of the arms 290a in respective elongate apertures 320 provides for slidable and pivotal coupling between first housing member 180 and second housing member 190. Thus, the second housing member 190 is axially slidable along a longitudinal axis of the housing 201 of the electronic device 100 when in an open position to bring respective adjacent edges 418 and 419 of first display screen 150 and said second display screen 155 into side by side juxtaposition with their respective exposed screen surfaces lying substantially coplanar.

Electrical and mechanical coupling of spigot 212 and socket 213 occurs when housing members 180,190 are urged together when the spigot 212 and socket 213 are aligned. When first display screen 150 and second display screen 155 are in an edge to edge abutting relationship, the two screens together can form a larger viewing area, particularly in a landscape mode for playing electronic games.

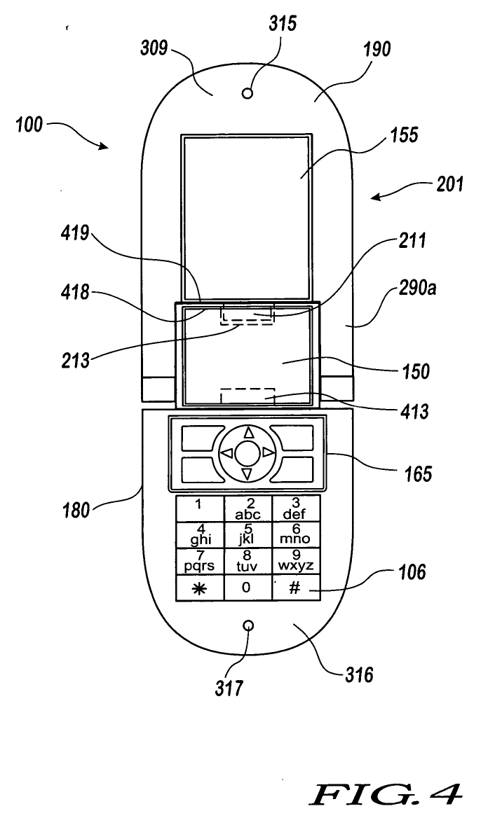

FIG. 4 shows the electronic device 100 in a final open position wherein first housing member 180 and second housing member 190 are urged together to obtain an electrical coupling between electrical spigot 212 and electrical socket 213 to form an electrical communication between the second display screen 155 and processor 103. This movement of the housing 201 of device 100 from the closed position to the final open position is possible since second housing member 190 and said first housing member 180 are: a) pivotally mounted to each other, about pivotal axis 206; and b) slidably movable relative to each other (due to arms 290a being slidably mounted to and captive elongate apertures 320) between a position adjacent one end of first housing member 180 and a position intermediate opposite ends of first housing member 180.

The socket 213 and spigot 212 when operatively engaged have a secondary function of providing a locking mechanism locking the device 100 in the final open position. Also, when operatively engaged so that spigot 212 is electrically coupled with socket 213 in the final open position shown in FIG. 4, respective edges 418 and 419 of display screens 150 and 155 are in a substantially edge to edge abutting juxtaposition to function as a single large display screen or two separate display screens with screen display modes being selected by, for example, auxiliary keys 165. When spigot 212 and socket 213 are electrically coupled, electrical power and signal connectivity is provided to second display screen 155 for illumination purposes and any other functional purposes. For example, part or all of second display screen 155 may be adapted to function as a touch screen to provide a further or alternative user input interface. Also, connectivity between the processor 103 and speaker 140 is provided when spigot 212 and socket 213 are electrically coupled.

In the final open position as shown in FIG. 4, the device 100 can then function as a mobile telephone or alternatively the device 100 may be operated to send and receive SMS, MMS and EMS messages as well as to play games in an enlarged screen mode. In a split screen mode, display screen 150 may continue to provide simple time and date information or it may show text information while image data is displayed on screen 155. It should be noted that when the device 100 is in the closed position, the spigot 212 engages in a snap fitment relationship with a socket 413 to thereby lock the device 100 in this closed position. This socket 413 has no electrical contacts and purely function as a lock when it receives the spigot 212.

FIG. 5 illustrates a cross-sectional view through 2-2′ in FIG. 2 showing the slidably captive and pivotal coupling between first housing member 180 and second housing member 190. Arms 290a of second housing member 190 are formed with inwardly directed shaped cam elements 530 spaced from respective arms 290a by cylindrical bosses 531. Housing elements 321,322, which, together form first housing member 180, also form cavities 533. In a closed position shown, first and second housing members 180,190 are urged together under the influence of leaf springs 532 or the like located in two of four cavities 533, these leaf springs 532 co-act with respective cam elements 530 to provide a yieldable resistance to opening and closing of the device 100. Cylindrical bosses 531, after the yieldable resistance is overcome by a suitable force, are thus able to rotate and to slide within the apertures 320 formed between housing elements 321, 322 thereby providing for the opening and closing of the device 100 during relative rotation and sliding of members 180,190. Also shown is a circuit board 556 on which components including processor 103 are mounted.

FIGS. 6 to 8 show an alternative embodiment to that illustrated in FIGS. 2 to 5. Referring firstly to FIG. 6, it can be seen that the electronic device 100, in the closed position shown, is substantially identical to the configuration of that shown in FIG. 2 except that arms 190a, forming the side boundaries of slotted opening 204, include longitudinally extending projections 600. If required, end face 214 may be slightly tapered inwardly towards an edge 601 of display screen 150 to engage, in an open position with a complimentary tapered face 602 on second housing member 190. Second housing member 190 is pivotally coupled to first housing member 180 about a fixed pivotal axis 606.

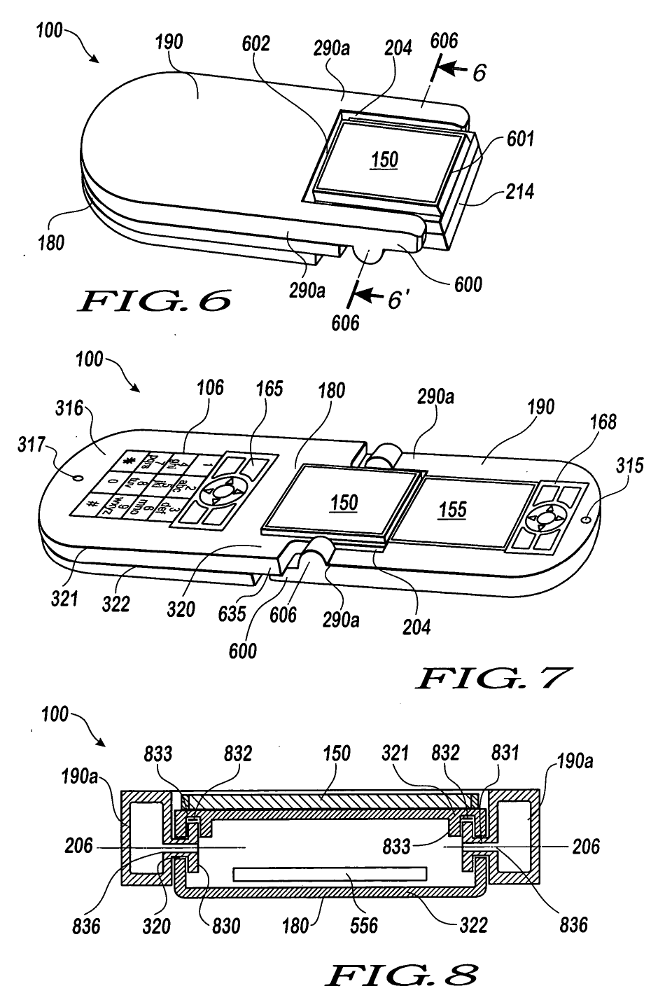

FIG. 7 shows the device 100 of FIG. 6 in an open position with projections 600 locating under abutments 635 formed in first housing member 180 to prevent over rotation of second housing member 190 about pivotal axis 606 relative to first housing member 180 and thereby retain the adjacent display screens 150,155 in a substantially coplanar relationship in the open position shown. Additionally or alternatively over rotation may be prevented by engagement of complimentary end faces 214 and 602 of first housing member 180 and second housing member 190 respectively.

An optional feature with the electronic device according to the invention is an additional user input interface in the form of auxiliary keys 168 in second housing member 190, which, together with a user input interface in the form of auxiliary keys 165 in first housing member 180, facilitate two handed control for an electronic game played with the enlarged screen display area in a landscape mode. Typically for such two handed control, and as illustrated, auxiliary keys 165 and auxiliary keys 168 are located adjacent respective free ends of the first housing member 180 and second housing member 190. FIG. 8 shows a cross-sectional view through 6-6′ in FIG. 6. This embodiment differs from that of FIG. 5 in that arms 290a are hollow to accommodate flexible electrical or optical conductors (not shown) to permit electrical coupling between second display screen 155 and second auxiliary keypad 168 (if present) and processor 103 located in first housing member 180 via a hollow aperture 836 in one or both cylindrical bosses 831 supporting cam elements 830. As with the embodiment illustrated in FIG. 5, leaf springs 832 or like biasing members are located in respective cavities 833 to co-act with cam elements 830 to bias first and second housing members 180,190 into a closed position when they approach an abutting juxtaposition.

The present invention may, if required, reduce the physical dimensions of devices whilst having the option of a larger single or virtually single display screen comprising two display screens. Hence, the present invention permits a large viewable display screen area which may function as a single image display, a split image display, a combination of image and touch screen display or a combination of data and image depending upon the mode selected by a user. At the same time, the electronic device retains a compact form having the option of a larger single or virtually single display comprising two display screens.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential feature or elements of any or all the claims. The invention is defined solely by the appended claims including any amendments made during the pendency of this application and all equivalents of those claims.

We claim:

1. An electronic device comprising:
a housing having a first housing member and a second housing member movably mounted to each other to allow relative movement thereof between an open position and a closed position, said first housing member and said second housing member each having an inner face such that at least part of the inner face of the second housing member is facing and proximal to the inner face of the first housing member when said device is in the closed position;
a first display screen is located on the inner face of said first housing member and visible via an opening in said second housing member when said device is in a closed position;
a second display screen located on the inner face of said second housing member and locatable in a substantially edge to edge juxtaposition with said first display screen when said device is in an open position; and
at least one user input interface mounted to the housing.

2. A device as claimed in claim 1 wherein said first display screen protrudes into said opening when said device is in the closed position.

3. A device as claimed in claim 2 wherein said second housing member and said first housing member are pivotally mounted to each other about a pivotal axis slideably movable between a position adjacent one end of said first housing member and a position intermediate opposite ends of said first housing member.

4. A device as claimed in claim 2 wherein said second housing member is axially slidable along a longitudinal axis of said electronic device in an open position to bring adjacent edges of said first display screen and said second display screen into side by side juxtaposition with respective exposed screen surfaces lying substantially coplanar.

5. A device as claimed in claim 4 wherein said second housing member and said first housing member are lockable in the open position by a locking mechanism.

6. A device as claimed in claim 5 wherein said locking mechanism comprises a socket and spigot mechanism.

7. A device as claimed in claim 6 wherein said socket and spigot mechanism comprises an electrical coupling between said second body member and said first body member.

8. A device as claimed in claim 2 wherein said first display screen and said second display screen together function as single large display screen when said device is in the open position.

9. A device as claimed in claim 2 wherein said first display screen and said second display screen function as two separate display screens when said device is in the open position.

10. A device as claimed in claim 1 wherein said user input interface comprises one or more keypads mounted on said first housing member.

11. A device as claimed in claim 1 wherein said user input interface comprises at least one touch sensitive display screen.

12. A device as claimed in claim 11 wherein said at least one touch sensitive display screen is incorporated into said first display screen.

13. A device as claimed in claim 2 wherein the user interface includes a first interface incorporated in said first housing member and a second interface incorporated in said second housing member, wherein said first interface and second interface are located adjacent respective free ends of said first housing member and said second housing member.
